(19) United States
(12) Patent Application Publication
(10) Pub. No.: US 2019/0347449 A1
(43) Pub. Date: Nov. 14, 2019

(54) PRIVACY PROTECTION SYSTEM FOR ELECTRONIC DEVICES

(71) Applicant: DANA CONRAD KOWASIC, Winchester, VA (US)

(72) Inventor: DANA CONRAD KOWASIC, Winchester, VA (US)

(21) Appl. No.: 16/518,753

(22) Filed: Jul. 22, 2019

Related U.S. Application Data
(60) Provisional application No. 62/723,239, filed on Aug. 27, 2018.

(51) Int. Cl. G06F 21/83; G06F 21/84; H04B 1/3888; H04M 1/725

(52) U.S. Cl. CPC G06F 21/83; G06F 21/84; H04M 1/72575; H04M 1/72577; H04B 1/3888

(57) ABSTRACT

The present invention relates to securing a private conversational, photo and video environment in a home or office from the eavesdropping capability of an electronic devices microphone and the camera while wireless charging the electronic device in those private and sensitive environments. The invention is comprised of an enclosure to hold the electronic device with an inclusive wireless charging unit built into the inventions enclosure body. The enclosure can be of many embodiments such as an open design with internal LED lights, a semi-open design with a diffused translucent ¼ top cover, and a design with a full lift up door covering unit that can be either solid or a full translucent lift up door with a ¼ top area that is diffused, all embodiments would prevent the internal camera of the electronic device from taking accurate photo or video of its surroundings outside of the enclosure while the device is wirelessly charging in the invention. All embodiments of the invention would allow the user to visually see alerts and activity on their electronic device's screen while placed onto the inventions wireless charging base. All embodiments of the invention would include an attached frequency generator and internal micro ultrasonic speakers which when an electronic device is placed onto the wireless charging base the invention will then actively electronically broadcast an audio disillusionment frequency/sound undetectable to the human ear but which would disrupt the ability of the electronic device microphone to disseminate sounds or record words spoken outside of the inventions enclosure. The enclosed electronic devices ringer and speakers would not be affected by the audible frequency so that the alert capabilities of the device are not compromised.

### CROSS-REFERENCE TO RELATED APPLICATIONS

This application claims the benefit of U.S. Provisional Application No. 62/723,239 filed on Aug. 27, 2018, entitled “Privacy protection system and wireless charger for electronic devices capable of recording audio, photo and video.”

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention relates to the cellular phone and electronic device privacy in private home and/or work environment. More particularly, the invention relates to securing a private conversational and/or recordable photo and video environment in a home or office from the eavesdropping capability of an electronic devices microphone and the camera while wireless charging the electronic device in those private and sensitive environments.

### BACKGROUND OF THE INVENTION

The present invention relates to the cellular phone and electronic device privacy in the private home and/or work environment. More particularly, the invention relates to securing a private conversational and/or recordable photo and video environment in a home or office from the eavesdropping and recording capability of an electronic devices microphone and the camera while wireless charging the electronic device in those private and sensitive environments. Today, a majority of the population carries a personal electronic device on or with them at all times, many people cannot physically be without these important personal devices such as cellular/smartphones, smart watches, smart pads and other electronic aids because of the ability to instantly communicate with other people, either that being family, friends or employer-related duties and functions. People are very concerned about their personal privacy with these electronic devices, especially in the sensitive home bedroom or work office environments.

In normal routine life mobile, laptop & other portable smart devices normally leave the camera, mic & system exposed at all times. This fact is totally in line with normal household and daily life routine. The ubiquity of digital equipment, such as smartphones and wearable technology, has created privacy concerns. The increasing number of applications and software are around in the market, which unknowingly acts as spy base for individuals, companies and government organizations, where the user is normally not even aware of the background activities taking place.

In the same context of privacy of electronic device, another aspect is hacking of the system through different software and applications and further misuse of personal data especially the images and photographs. Accordingly, it would be desirable to provide techniques for automated privacy protection. For example, music, photographs and video can be obtained from the open cameras and mic of electronic systems and further stored and transmitted as a series of numbers, such as 1's and 0's. Unfortunately, digital techniques also let the information be easily copied without the information owner's permission.

Electronic devices such as cellular/smartphones, smart watches, and smart pads today are so advanced that they are always actively listening for input while recording conversations and are capable of recording and disseminating photos and video to its surroundings on a constant undetectable basis. Changing the electronic devices settings can deactivate a live microphone or camera but individual downloadable apps installed on these devices can covertly keep the microphone active and listening constantly or the camera undetectably active because authorization to listen, record spoken words, capture photo/video of its surroundings is more often a required function when the app is downloaded onto these electronic devices. People need the confidence that what is said and done or what is visually active in the bedroom, work office environment, etc. is private and secure but individuals also need to be able to respond to a call or message that comes on their electronic device in a reasonably quick timeframe. A device that can wirelessly charge the battery of an electronic device while also disrupting the audio recording/listening and the photo, video capture capabilities of the electronic device is needed as a unique firewall for the privacy of an individual home or work environment setting.

### SUMMARY OF THE INVENTION

The invention is an audio and video privacy enclosure surrounding and including a wireless electronic device charger with an attached translucent modified privacy lift up top cover/retractable lid. The enclosure can be a multitude of colours or privacy translucent, the lift up top cover/retractable lid can be a multitude of colours or privacy translucent. Using privacy translucent materials on the lift up top/retractable lid would enable the individual to visually see incoming texts, or alerts while the electronic device was wirelessly charging in the sound barrier enclosure but would visually disrupt the recording and disseminating capabilities of electronic devices internally attached the camera. The enclosures inner walls would have small inward micro ultrasonic speakers which would be electrically powered and would broadcast an inaudible audio disillusionment “white noise” sound undetectable to human hearing but discernible to the hypersensitive microphone of the electronic device that would disrupt the ability of the electronic devices microphone to disseminate and/or record audible words being spoken outside of the wireless privacy charger enclosure. The bottom of the unit inside would be a flat surface base comprising the latest wireless charging technologies to wirelessly charge the battery of an enclosed electronic device.

The invention is comprised of an enclosure to hold the electronic device with an inclusive wireless charging unit built into the inventions enclosure design. The enclosure can be of many embodiments such as an open design with a full lift up door covering unit that can be either solid or a full translucent lift up door with a ¼ top area that is diffused, an open design with internal LED lights, and a semi-open design with a diffused translucent ¼ top cover, all embodiments would prevent the internal camera of the electronic device from taking accurate photo or video of its surroundings outside of the enclosure while the device is wirelessly charging in the invention. All embodiments of the invention would allow the user to visually see alerts and activity on their electronic devices screen while placed onto the inventions wireless charging base.

All embodiments of the invention would include an attached frequency generator and internal micro ultrasonic speakers which when an electronic device is placed onto the wireless charging base the invention will then actively electronically broadcast an inaudible audio disillusionment “white noise” sound undetectable to the human ear but which would disrupt the ability of the electronic device microphone to disseminate sounds or record words spoken outside of the inventions enclosure. The enclosed electronic devices ringer and speakers would not be affected by the audible frequency so that the alert capabilities of the device are not compromised.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

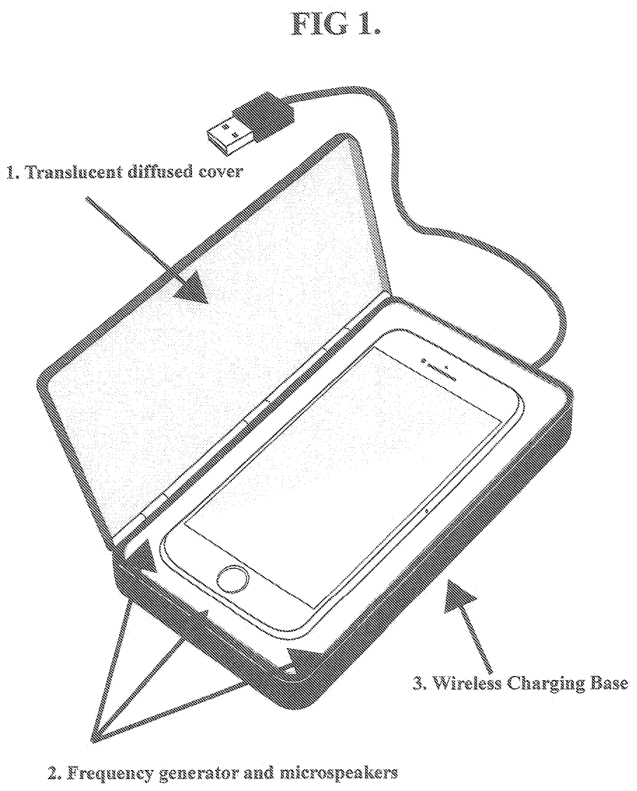

FIG. 1, FIG. 1 illustrates the embodiment of the invention with the attached translucent and diffused lift up top cover.
1. top attached translucent lift/up diffused top cover lid with diffuser element built into the cover.
2. internal frequency generator and micro ultrasonic speakers for broadcasting an inaudible audio disillusionment “white noise” sound capable of disrupting the recording and voice recognition ability of the smartphone microphone
3. wireless charging base

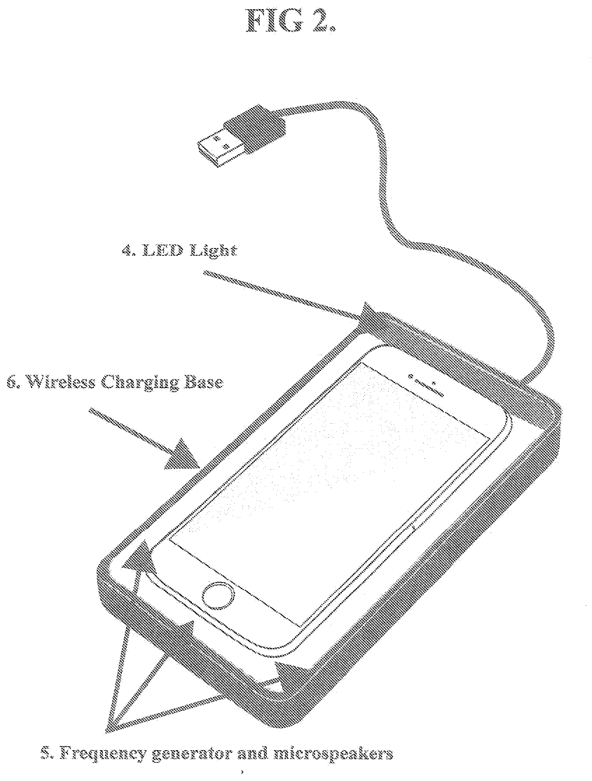

FIG. 2 FIG. 2 illustrates the embodiment of the invention withan open air top design.
4. LED light for diffusion of the image taking the ability of a smartphone camera.
5. internal frequency generator and micro ultrasonic speakers for broadcasting an inaudible audio disillusionment “white noise” sound capable of disrupting the recording and voice recognition ability of the smartphone microphone.
6. wireless charging base

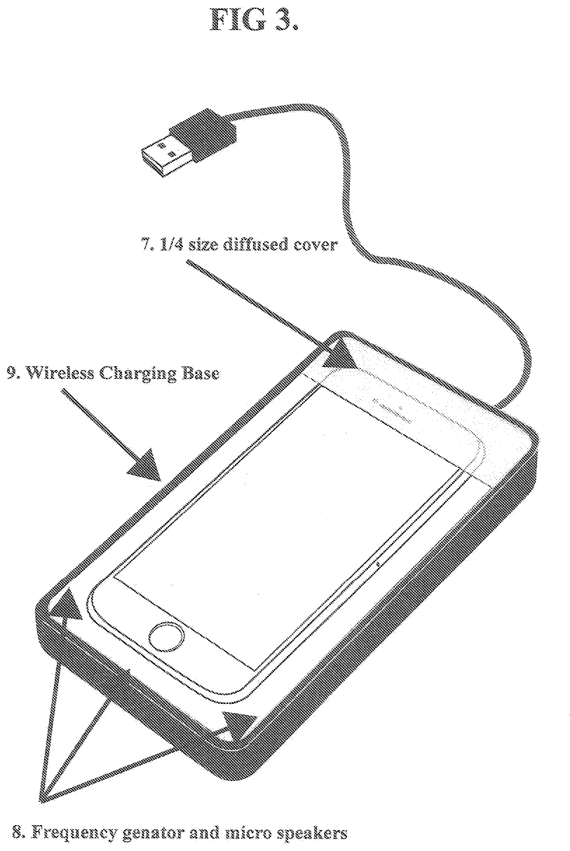

FIG. 3. FIG. 3 illustrates the embodiment of the invention with an accessible top area above the raised enclosure frame with an attached security liftable or fixed ¼ surface size transparent diffused lid cover.
7. top attached translucent fixed or lift up ¼ size top cover lid with diffuser element built into the cover.
8. internal frequency generator and micro ultrasonic speakers for broadcasting an inaudible audio disillusionment “white noise” sound capable of disrupting the recording and voice recognition ability of the smartphone microphone.
9. wireless charging base

### DETAILED DESCRIPTION OF THE INVENTION

The invention is a privacy enclosure and wireless charging station for all types of electronic devices that support wireless charging technologies, the inside bottom of the invention is a wireless charging pad which would be a fiat base which an electronic device can be placed on top and be used to wirelessly charge the electronic device, the surrounding raised enclosure walls on the sides will have an attached top covering unit door or retractable top that will lift up and down onto the enclosure body seamlessly. When the electronic device is placed in the wireless charging enclosure the top door/cover could be made of any variety of colors and solid materials and or translucent materials so that an individual can or cannot see the smartphone's screen inside the closed enclosure so that the electronic devices camera is disrupted from recording and disseminating accurate photo or video of its surroundings out of the inventions enclosure, the inner wall sides of the enclosure would have an attached frequency generator and internal micro ultrasonic speakers which electronically would broadcast an audio disillusionment frequency/sound which would disrupt the ability of the electronic devices microphone to disseminate sounds and/or record spoke words outside of the inventions enclosure. The enclosed electronic device's ringer and speakers would not be affected by the audio disillusionment “white noise” frequency produced so that the alert capabilities of the electronic device are not compromised while placed in the inventions charging area. To use the electronic device as intended just lift the top cover door of the inventions raised enclosure and pick up the electronic device from the wireless charging pad that is inclusive of the inventions device design.

In another embodiment the invention is a privacy enclosure and wireless charging station for all types of electronic devices that support wireless charging technologies, the inside bottom of the invention is a wireless charging pad and would be a flat base which an electronic device can be placed on top and be used to wirelessly charge the electronic device, the raised enclosure walls will surround the sides of the invention and have an open accessible top area above the raised enclosure frame. When the electronic device is placed on the wireless charging enclosure base, the inside top and bottom ends of the enclosures inner walls would have automatic diffuser LED lights pointing towards the placed electronic devices camera that will turn on once an electronic device is placed in the inventions holding charging area, the light would disrupt the ability of the electronic devices attached active camera from disseminating and recording accurate photo or video of its surroundings outside of the inventions outer enclosure walls, the inner wall sides of the surrounding enclosure would also have an attached frequency generator and internal micro ultrasonic speakers which will electronically broadcast an audio disillusionment frequency “white noise” sound undetectable to the human ear but which would disrupt the ability of the electronic device to disseminate and/or record sounds and words spoken outside of the inventions raised enclosure walls. The enclosed electronic devices ringer and speakers would not he affected by the audible frequency so that the alert capabilities of the device are not compromised. To use any electronic device as intended just pick up the electronic device from out of the inventions open raised enclosure and pick up the electronic device from the wireless charging pad that is inclusive to the invention device design.

In another embodiment the invention is a privacy enclosure and wireless charging station for all types of electronic devices that support wireless charging technologies, the inside bottom of the invention is a wireless charging pad and would be a flat base which an electronic device can be placed on top and be used to wirelessly charge the electronic device, the raised enclosure walls will surround the sides of the invention and have an accessible top area above the raised enclosure frame with a security liftable or fixed ¼ surface size transparent diffused lid cover that would be present over the top portion of an electronic device where the internal camera lenses are located and actively in use. The electronic device would have lift and place access with this top cover door in place, but the transparent diffused lid would disrupt the visual ability of the electronic devices lens to record and disseminate accurate photo or video of the exterior outside of the enclosure since the diffuser element in the transparent top cover would block the visual recording and disseminating capabilities of the electronic devices internal camera to take accurate photo or video outside of the invention enclosure, the inner wall sides of the surrounding enclosure would also have an attached frequency generator and internal micro ultrasonic speakers which will electronically broadcast an audio disillusionment frequency “white noise” sound undetectable to the human ear but which would disrupt the ability of the electronic device microphone to disseminate sounds and/or record words spoken outside of the inventions raised enclosure walls. The enclosed electronic devices ringer and speakers would not be affected by the audible frequency so that the alert capabilities of the device are not compromised. To use any electronic device as intended just pick up the electronic device from out of the inventions open raised enclosure and pick up the electronic device from the wireless charging pad that is inclusive to the invention device design.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention.

Having described my invention, I claim:

1) A speech photo and video privacy protection system for electronic devices capable of recording audio, photo, and video comprising: a wireless charging enclosure; a surrounding frequency emitting privacy enclosure; an attached full-size privacy lift up top hatch/door and/or retractable top.
wherein said closeable top design with an attached full size privacy translucent lift up or retractable top hatch/door with a implanted diffuser element which will disrupt the image recognition and visual disseminating capability of an electronic devices front or rear facing camera while placed in the inventions wireless charging enclosure of the invention.
wherein said invention would contain and include a wireless charging bottom/pad base which wirelessly charges all types of cellular devices, smart watches, smart pads and other electronic devices.

2) A speech, photo, and video security protection system for electronic devices capable of recording audio, photo, and video comprising: a wireless charging enclosure; a raised surrounding sound; a semi open-air accessible top design above the enclosure frame with a privacy liftable or fixed ¼ surface size transparent diffused overlay located at the top portion of an electronic device where the internal camera lenses are located and actively in use.

3) The device of claim 1, wherein said surrounding enclosure configured with a frequency generator and internal micro ultrasonic electrically powered speakers which would broadcast an inaudible audio disillusionment “white noise” sound that can disrupt the recording eavesdropping and voice disseminating capabilities of microphones attached to the cellular phones, smart watches, smart pads and any many another electronic device.

4) The device of claim 1, wherein said invention would contain and include a wireless charging bottom/pad base which wirelessly charges all types of cellular devices, smart watches, smart pads and other electronic devices.

6) The device of claim 1, wherein said open-air accessible top design with light emitting properties from the top front rim of the raised enclosure walls which will disrupt the image recognition and disseminating capability of an electronic devices front or rear facing camera by creating a washout effect.

7) The device of claim 1, wherein said surrounding enclosure configured with an internal frequency generator and micro ultrasonic electrically powered speakers which would broadcast an inaudible disillusionment “white noise” sound that can disrupt the recording eavesdropping and voice disseminating capabilities of microphones attached to the cellular phones, smart watches, smart pads and any other electronic device.

8) The device of claim 2, wherein said semi open-air top design with a privacy liftable or fixed ¼ surface transparent diffused overlay located at the top rim of the raised enclosure walls which will disrupt the image recognition and disseminating capability of an electronic devices front or rear facing camera while place in the wireless charging enclosure of the invention.

9) The device of claim 2, wherein said surrounding enclosure configured with an internal frequency generator and micro ultrasonic electrically powered speakers which would broadcast an inaudible audio disillusionment “white noise ” sound that can disrupt the recording eavesdropping and voice disseminating capabilities of microphones attached to the cellular phones, smart watches, smart pads and any other electronic device.

10) The device of claim 2, wherein said invention would contain and include a wireless charging bottom/pad base which wirelessly charges all types of cellular devices, smart watches, smart pads and other electronic devices.

11) The device of claim 2, wherein said invention would include privacy charger be a plugged in vehicle unit.
